(19) United States
(12) Patent Application Publication
(10) Pub. No.: US 2002/0118917 A1
(43) Pub. Date: Aug. 29, 2002

(54) Light receiving device

(76) Inventor: Motoyoshi Kawai, Tokyo (JP)

Correspondence Address: McGINN & GIBB, PLL,, 8321 OLD COURTHOUSE RD., Suite 200, VIENNA, VA, 21254, US

(21) Appl. No.: 09/492,523

(22) Filed: Jan. 27, 2000

(30) Foreign Application Priority Data
Jan. 26, 1999 (JP) 56021/1999

(51) Int. Cl. G02B 6/26; G02B 6/30

(52) U.S. Cl. 385/31; 385/49; 385/88

(57) ABSTRACT

A light receiving device including an optical waveguide medium (optical fiber) for emitting signal light from an outgoing end, and a light receiving element for receiving the signal light by a light receiving surface and converting the signal light into an electric signal. The outgoing end has a surface cut with a blade saw perpendicular to a traveling direction of the signal light, and an index-matching material exhibiting a refractive index larger than 1 but less than a refractive index of the light receiving element, fills between the outgoing end and the light receiving surface. The surface roughness Rz of the end surface of the optical fiber is preferably over 0.04 μm. The formation under this condition may involve the use of the blade saw having an abrasive grain specified by a grain number smaller than #2000. The light receiving element is disposed so that the light receiving surface is oblique to the traveling direction of the signal light. The light receiving device, particularly, a surface packaging type light receiving device is constructed to have a desired low reflection characteristic while attaining the downsizing and a high productivity.

### BACKGROUND OF THE INVENTION

1. Field of the Invention

The present invention relates generally to a light receiving device used for a light receiving module in an optical communications system and for a light receiving unit of an optical data processor, and more particularly to a light receiving device in which a reflection of the incident light is restrained small.

2. Description of the Related Art

In an optical communications system, if there is reflection point within a light receiving device provided in a receiving apparatus, an oscillating state of a semiconductor laser provided on the side of a transmitting apparatus is destabilized by the light reflected therefrom. The reflected light might induce multiple reflections inside a transmission path, which might also cause declines of a distortion characteristic and a noise characteristic of the communications.

Especially in a field of an analog light transmission such as an optical CATV etc, if there are large reflection points in a semiconductor laser module provided on the side of the transmitting apparatus and in a light receiving module provided on the side of an optical connector or the receiving apparatus, the problem described above is brought about, and a desired transmission characteristic can not be obtained. As for those problems, even when the light receiving device is applied to the optical data processing system or the like, the similar problems might arise due to the reflections.

Such being the case, what is highly demanded of the light receiving device is to reduce an inside reflection quantity in order to prevent the signal light which has been once incident from being reflected and again traveling back to the outside. A quantity of the inside reflection is characteristically evaluated normally in the form of a reflection attenuation quantity. For instance, a reflection attenuation quantity as strict as approximately −40 dB or under is required of the analog light transmission such as the optical CATV etc. described above.

According to the prior art, for reducing the reflections within the light receiving device described above, as disclosed in, e.g., Japanese Examined Patent Publication Nos.Hei 4-013896 and 6-072969, the outgoing end of an optical fiber is obliquely polished, thereby restraining the reflection from the light receiving module such as a fiber terminal and a light receiving element surface etc. (see FIG. 1). That is, there exists an air layer between the outgoing end and the light receiving surface of the light receiving element, and a beam of return light caused by Fresnel reflection occurred by a difference in refractive index between the outgoing end and the air layer is prevented from traveling back to an optical path formed by obliquely shaping the outgoing end. The reflection attenuation quantity under −40 dB can be thereby ensured.

Incidentally, with progresses of downsizing and mass production of the light receiving device, there appears a small-sized module taking a form different from the light receiving module in which the conventional parts are individually assembled. The small-sized module has such a structure that an optical semiconductor device is packaged on a silicon substrate, a fiber is set in a V-shaped groove formed in the silicon substrate, thereby making optical coupling between the optical semiconductor device and the fiber. A package accommodates this optical system unit. The small-sized module is suitable for surface packaging onto a printed board. The surface packaging type optical module is disclosed in, e.g., “Development of Surface Packaging Type Optical Module” (Lecture Number SC-1-12), Kurata et al, the lecture report in the 1995 Electronics Society Meeting of the Electronic Information Communications Association.

Even the light receiving module adopting such a construction is required to obtain a high reflection attenuation quantity characteristic. Therefore, as in the case of the light receiving module having the conventional construction described above, the light receiving element is packaged so that the light receiving surface of the light receiving element is oblique to the optical fiber. Further, the outgoing end of the optical fiber is formed obliquely to the optical fiber.

The surface packaging type optical module, however, uses a bare fiber (a stranded optical fiber) and a carbon-coated fiber, and it is therefore required that those fibers be obliquely polished, which results in a very poor operability. In addition, a problem, which might arise when the optical fiber is set in the V-shaped groove, is a difficulty of setting a direction of a polishing surface of the fiber end surface. When the outgoing end of the optical fiber is obliquely formed in the case of disposing the light receiving surface of the light receiving element obliquely to the optical fiber, the light is emitted in an oblique direction according to the Snell's law. Hence, there might be a case where the essential optical coupling can not be obtained unless the light receiving element is disposed in a proper position and in a proper direction.

In contrast with this arrangement, if the optical fiber is set in the V-shaped groove in an arbitrary direction of the polishing surface and the light receiving surface of the light receiving element takes a positional (directional) relationship of verticality to the optical path of the light emitted, the light reflected from the light receiving surface travels along the same optical path as that of the emitted light and arrives again at (couples to) the optical fiber. This might result in such a problem that the above light eventually turns out a beam of reflection return light. As for the former problem, there is a case where a quantum efficiency of which the light receiving device is demanded can not be satisfied. By contrast, the latter case leads to an incapability of satisfying the reflection attenuation quantity.

In other words, according to the conventional construction, it is quite difficult to dispose the light receiving element by setting a proper angle to the optical path for the signal light while obliquely forming the outgoing end of the optical fiber and obliquely emitting the signal light. Particularly, as in the conventional light receiving module, an optical axis of one of the optical fiber and the light receiving element is adjusted for obtaining the optical coupling therebetween, and, in such a case, the position can be also set while monitoring a characteristic such as a light receiving level etc. If packaged by setting the position and the direction of the light receiving element through positioning of a mark or the like without making those adjustments, however, an angle of the emitted light deviates vertically and laterally depending on an angle at which to dispose the optical fiber, resulting in a difficulty of assuring the characteristic with stability.

Thus, in the surface packaging type optical module, it is desirable that the end surface of the outgoing end of the optical fiber be vertically formed in order to make use of its feature. As described above, however, there still exits the problem of the reflection attenuation quantity, and that must be hard to actualize. Essentially, the process itself of obliquely forming the end surface does not exhibit a high productivity, and hence what is advantageous if capable of applying the optical fiber having the vertical outgoing end, is not limited to the surface packaging type optical module, and this is also the same with respect to the conventional construction, that is, a discrete type light receiving device constructed by assembling the individual parts. In the light receiving device of which a given reflection attenuation quantity characteristic is demanded, however, this can not be met by the vertical outgoing end, and hence the light receiving device having such an outgoing end is not yet actualized.

### SUMMARY OF THE INVENTION

It is an object of the present invention to provide a light receiving device having a low reflection characteristic, and particularly a surface packaging type light receiving device capable of having a desired low reflection characteristic while attaining its downsizing and a high productivity.

To accomplish the above object by obviating the problems given above, according to one aspect of the present invention, a light receiving device having a low reflection characteristic comprises an optical waveguide medium (e.g., an optical fiber and an optical waveguide) for emitting a beam of signal light from an outgoing end, and a light receiving element for receiving the signal light by a light receiving surface and converting it into an electric signal. In the light receiving device according to the present invention, the outgoing end is a surface formed by cutting the optical waveguide medium with a blade saw so as to be substantially perpendicular to a traveling direction of the signal light, and an index-matching material exhibiting a refractive index larger than 1 fills between the outgoing end and the light receiving surface.

Herein, the surface roughness Rz of the surface forming the outgoing end may be set on the order of, for example, 0.04 μm or above in order to obtain a necessary coupling efficiency while gaining a reflection attenuation quantity. For forming such a surface, the blade saw which may be used has an abrasive grain specified by a grain number smaller than #2000.

In the construction described above, it is preferable for preventing a decrease in the coupling efficiency between the optical waveguide medium and the light receiving element that the surface roughness Rz of the surface be on the order of 0.06 μm or under. For forming the above surface under such a condition, there may be used the blade saws having an abrasive grain specified by a grain number larger than #500 under the above-described condition.

According to another aspect of the present invention, a light receiving device comprises an optical waveguide medium for emitting a beam of signal light from an outgoing end, and a light receiving element for receiving the signal light by a light receiving surface and converting it into an electric signal. The outgoing end of the optical fiber is a surface formed substantially perpendicular to a traveling direction of the signal light, of which the surface roughness Rz is over 0.04 μm, and an index-matching material exhibiting a refractive index larger than 1 fills between the outgoing end and the light receiving surface. The surface is formed by a final polishing finish using an abrasive grain specified by a grain number smaller than #2000.

In the light receiving device according to the present invention, the light receiving element is disposed so that the light receiving surface is oblique to the traveling direction of the signal light.

The light receiving device according to the present invention, which has the construction described above, further comprises a substrate formed with a groove in which to dispose the optical fiber, and a package in which the substrate formed with an optical waveguide and the light receiving element are disposed, the optical fiber or the optical waveguide and the light receiving element are optically directly coupled.

In the light receiving device having the low reflection characteristic according to the present invention, the outgoing end of the optical fiber etc. is formed by cutting with the blade saw, and the outgoing end surface is positively formed with ruggedness. This rugged surface is set in a face-to-face relationship with the light receiving surface of the light receiving element, thus obtaining a configuration for performing the direct optical coupling. Further, an index-matching material exhibiting a refractive index larger than a refractive index 1 of the air layer and preferably substantially equal to or larger than the refractive index of the optical fiber but less than a refractive index of the light receiving surface of the light receiving element, fills between the outgoing end and the light receiving surface. Those two items are combined to restrain the reflection from the outgoing end of the optical fiber, and improves the reflection attenuation quantity.

The end surface is formed with the ruggedness by cutting the outgoing end of the optical fiber with the blade saw, and consequently irregular reflections occur even when the Fresnel reflection is caused due to an unmatched state of the refractive index with respect to the outside. Therefore, the light becomes hard to be re-coupled directly to the core of the optical fiber. With only this contrivance, however, if the outgoing end is formed perpendicular to the optical fiber, there might a case in which a sufficient reflection attenuation quantity can not be ensured. Such being the case, according to the present invention, in addition to the construction described above, the index-matching material having a predetermined refractive index fills between the outgoing end of the optical fiber and the light receiving surface of the light receiving element, thereby reducing the Fresnel reflection itself.

According to the prior art, if the outgoing end is perpendicularly formed, an utmost reflection attenuation quantity as small as −20 dB is obtained. Based on the construction described above, however, a reflection attenuation quantity as large as −40 dB or under can be attained. A decrease in the quantum efficiency is never induced owing to the reduction in the Fresnel reflection due to the filling of the index-matching material.

Moreover, even when adopting the configuration in which the light receiving element is disposed obliquely to the optical fiber in order to decrease the reflection from the light receiving surface of the light receiving element, the light receiving element can be disposed without being aware of a polishing direction of the outgoing end of the optical fiber as in the case of the prior art. Namely, since the outgoing end is perpendicular to the optical fiber, the optical path for the emitted light is always aligned with the optical fiber. The light receiving element is disposed obliquely to the optical fiber, and hence, with the optical path being aligned, the reflected light from the light receiving surface is never re-coupled to the optical fiber. The direction of the optical path does not largely deviate.

### BRIEF DESCRIPTION OF THE DRAWINGS

The above and other objects, features and advantages of the present invention will become more apparent from the following detailed description when taken in conjunction with the accompanying drawings wherein:

FIG. 1 is a diagram showing one example of a construction of a conventional light receiving device;

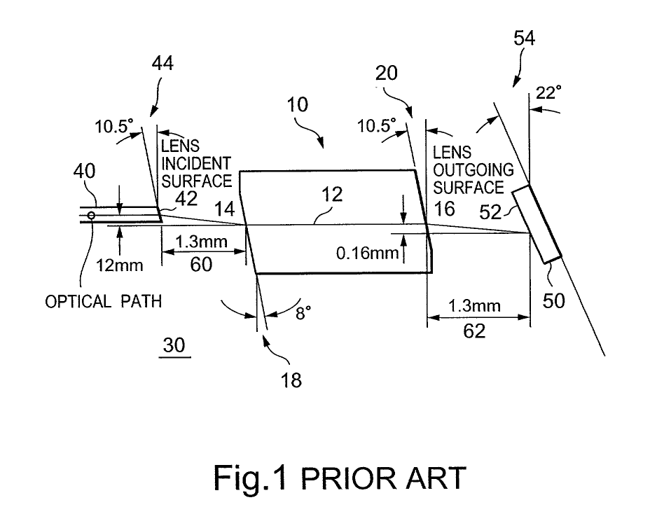

FIG. 2 is a diagram showing a construction of a first embodiment of a light receiving device having a low reflection characteristic according to the present invention;

FIGS. 3(a) and 3(b) are an enlarged view showing states of the outgoing ends of the optical fibers of the light receiving device having the low reflection characteristic according to the present invention and of the light receiving device in the prior art; FIG. 4(a) shows an example in the present invention; FIG. 4(b) shows an example in the prior art light receiving device; and

FIGS. 4(a) and 4(b) are a graph showing an evaluation result of reflection attenuation quantity at an outgoing end of an optical fiber in one embodiment of the light receiving device having the low reflection characteristic according to the present invention; FIG. 3(a) shows a result based on the construction of the light receiving device of the present invention; FIG. 3(b) shows a result based on the construction of the conventional light receiving device;

FIG. 5 is a diagram showing a construction of a second embodiment of the light receiving device having the low reflection characteristic according to the present invention.

### DESCRIPTION OF THE PREFERRED EMBODIMENTS

Next, embodiments of a light receiving device having a low reflection characteristic according to the present invention, will hereinafter be described in detail with reference to the accompanying drawings.

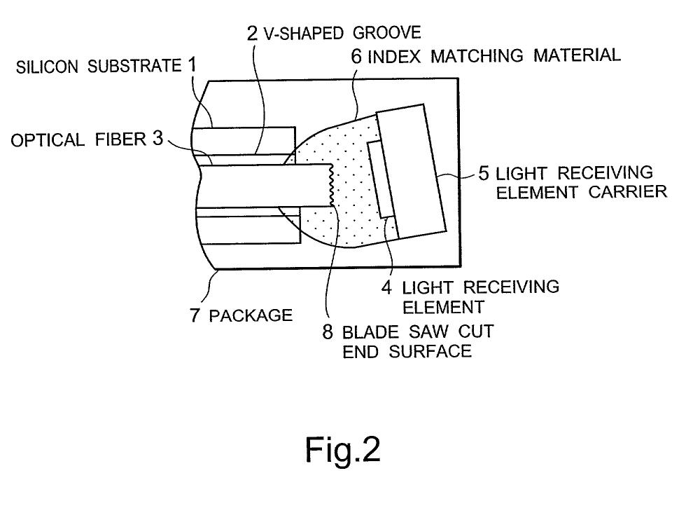

FIG. 2 is a diagram showing a construction of one embodiment of the light receiving device having the low reflection characteristic according to the present invention. Referring to FIG. 2, the light receiving device is constructed of a silicon substrate 1, a V-shaped groove formed in the silicon substrate 1, a fiber 3 coated with carbon, a light receiving element 4, a light receiving element carrier 5 packaged with the light receiving element 4, an index-matching material 6, and a package 7 for fixing the silicon substrate and the light receiving element carrier.

The optical fiber 3 is packaged in the V-shaped groove 2 formed in the surface of the silicon substrate 1. The optical fiber 3 is disposed in a face-to-face relationship with the light receiving element (e.g., a photo diode and an avalanche photo diode) 4.

As shown in FIG. 2, the light receiving element 4 is disposed so that a normal line of the light receiving surface thereof is inclined at 5˜10° to the optical fiber 3. This is because a beam of signal light from an outgoing end of the optical fiber 3 travels straight in an extending direction of the optical fiber 3 and impinges upon the light receiving surface, however, the signal light reflected therefrom does not travel back (this beam of light is not coupled) to the optical fiber due to its deflection. In such a case also, there arises a problem inherent in the configuration in the prior art, wherein the outgoing end of the optical fiber is obliquely formed by polishing, and hence an essential optical coupling can not be obtained unless the light receiving element is disposed in a proper position and in a proper direction.

By contrast, though eventually turned out a beam of reflection return light if the light receiving surface of the light receiving element has a positional (directional) relationship of being perpendicular to an optical path of the emitted light, this problem does not occur in the configuration of the present invention. In the configuration where the light receiving element 4 is obliquely disposed, if the former problem arises, there might be a case in which a quantum efficiency of which the light receiving device is demanded can not be satisfied. Reversely, the latter case leads to such a drawback that a reflection attenuation quantity can not be satisfied.

Based on such a configuration, according to the present invention, to begin with, an end surface of the optical fiber 3, i.e., its outgoing end 8 from which to emit the signal light is cut by a blade saw (a dicing saw), with its surface being finished in a rough state. The surface of the outgoing end 8 of the optical fiber 3 used in the present invention is formed so that an average surface roughness Rz falls within a range of approximately 0.04 ˜0.06 μm. A surface roughness Rz of the end surface mirror-finished by polishing in the prior art was on the order of 0.01 μm, and hence the surface of the outgoing end of the optical fiber used in the present invention is rougher than what was mirror-finished by polishing in the prior art. The surface roughness of the end surface of the optical fiber according to the present invention is smaller than 1.3 μm which is a wavelength of the emitted light.

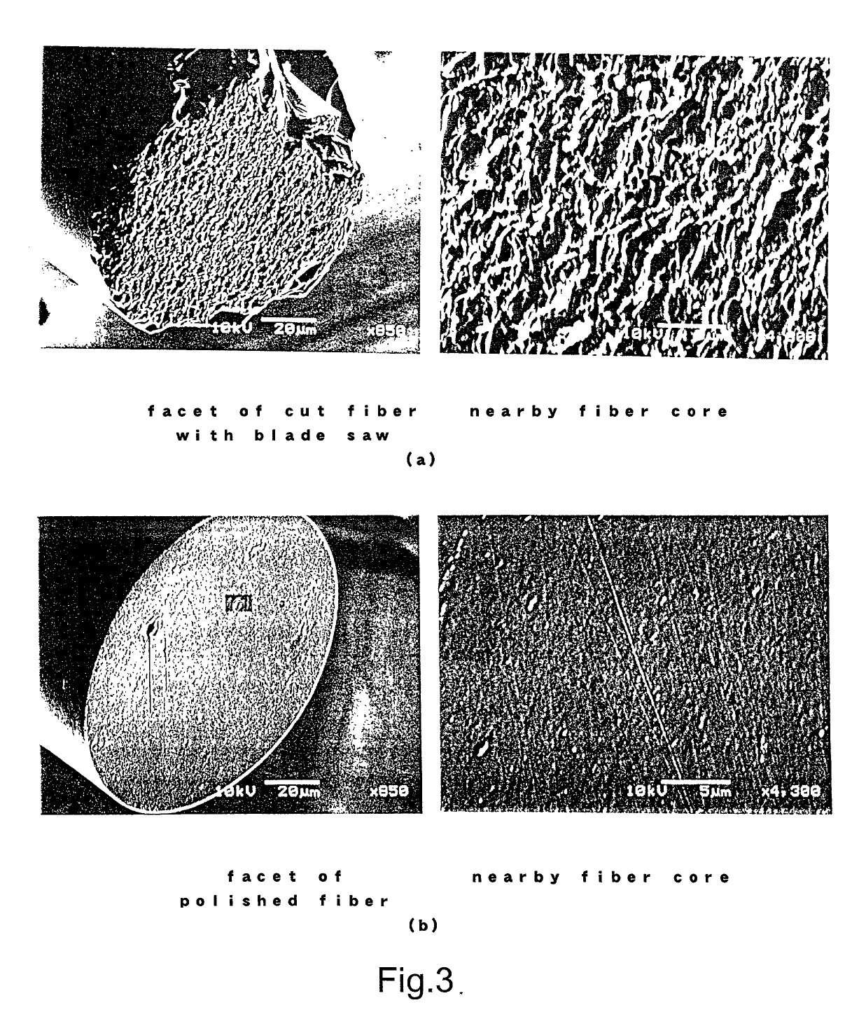

To observe it in an enlarged view of the outgoing end, as illustrated in FIG. 3(b), the end surface of the optical fiber which is formed by cleavage is flat (there is obtained a surface by flawing a side surface of the optical fiber and thus cleaving it, the surface being approximate to the mirror-finished surface by polishing). As shown in FIG. 3(a), the end surface of the optical fiber, which is formed by cutting with the blade saw, is rough with ruggedness. In the latter optical fiber, when the signal light strikes upon the outgoing end of the optical fiber, the signal light is irregularly reflected by the rugged surface thereof, and the reflected light is scattered. A quantity of the reflected light traveling again back to the core thereby decreases, and hence the reflection attenuation quantity based on such a configuration can be improved by far more than the reflection attenuation quantity of the former one, i.e., the optical fiber of which the outgoing end is formed by the cleavage.

Given next is more of a detail description of the contrivance for forming the rugged portion on the surface of the outgoing end positively obtained by cutting, as described above, the optical fiber with the blade saw.

The optical fiber is cut off with the blade saw while no polishing process is executed on the cut surface, and, with this process being ended as a final process, the outgoing end is thus formed, with the result that this outgoing end has more of ruggedness than the outgoing end formed by the mirror polishing finishing process which has been generally carried out so far. The formation of the surface having the ruggedness to such a degree as shown in FIG. 3(a), may involve the use of an abrasive grain of which a specifically designated size is on the order or #2000 or under. If largely rugged, however, a coupling loss due to the irregular reflection might increase, and for this reason there may be used what is specified to have preferably #500 or over. Incidentally, though scattered at the outgoing end in that case, because of being filled with the index-matching material and of the light receiving surface of the light receiving element being normally as large as 50 μm or more, it never happens that a large coupling loss is brought about.

When cutting the optical fiber with the blade saw having the abrasive grain falling within the above range, as in the case of polishing, the optical fiber having the end surface exhibiting the surface roughness described above can be obtained with a good reproducibility. Note that the blade saw having the abrasive grain of #1200 is used, and the number of revolutions is 15,000 rpm as a cutting condition taken in this embodiment. If the number of revolutions falls within a range of 10,000˜30,000 rpm, there is a small dependency upon the roughness of the finished surface, and substantially the same surface roughness as the above-mentioned can be obtained under any those conditions. According to this construction, the final finishing may be attained only by the cutting unlike the polish-based finishing, and hence it may be said that a more excellent mass productivity is gained.

Further, another contrivance for forming the outgoing end of the optical fiber may be to polish the surface by use of a specified size of abrasive grain. Normally, the polishing is done in sequence from a larger specified grain number, i.e., from a larger abrasive grain down to the smaller, then the mirror finishing by polishing is performed, and finally buffing is effected for attaining this. The surface roughness Rz of the buffed end surface is such as Rz =approximately 0.01 μm. Further, when finished with an abrasive grain of #6000 just before buffing, the surface roughness Rz is on the order of 0.02 μm.

What is specified within a range of #500˜#2000 may be preferable for obtaining the surface roughness Rz=approximately 0.05 μm. According to a test result, the surface can be finished as fine as Rz=approximately 0.06 μm if the abrasive grain is #500, further as fine as Rz=approximately 0.04 μm if the abrasive grain is #2000. By contrast, if finally finished with a larger abrasive grain of #500 or thereabouts, the surface roughness becomes too rough such as Rz=approximately 0.1 μm. If rough to this degree, however, there might be no decline in terms of a larger coupling loss for the same reason as what has been elucidated in the discussion on the blade saw.

This contrivance makes it feasible to form the end surface of the optical fiber with the surface roughness needed for the coupling structure according to the present invention simply by settling the designation of the abrasive grain for the final finishing. The polishing process, in the case of a comparatively small quantity of production, may not necessarily exhibit a higher productivity than in the cutting by use of the blade saw explained at first. In the case of a large quantity of production, the optical fibers can be polished in bundle, and therefore the productivity does not decline.

Furthermore, in the light receiving device of the present invention, the index-matching material having the refractive index approximate to the refractive index of the core of the optical fiber, fills between the outgoing end of the optical fiber 3 and the light receiving element 4. Note that the index-matching material may be gel or liquid. Particularly, the optical fiber 3 and the light receiving element 4 are disposed in close proximity to each other with no intermediary of a collective element such as a lens etc. so as to attain the optical coupling. Accordingly, even a liquid matching material, if having some degree of viscosity between the outgoing end and the light receiving surface, does not flow out by dint of its surface tension. It may be, however, preferable to use a hardening matching material in terms of considering the stability thereafter. It is to be noted that, for example, silicon resins and epoxy resins may be used as the specific index-matching materials. The matching material is not, however, limited to those resins if capable of exhibiting the above refractive index, obtaining the stability and ensuring a transparency with respect to the signal light.

Subsequently, a result of characteristic evaluation and an operation or the like of the light receiving device having the low reflection characteristic according to the present invention, will be explained with reference to FIGS. 2 through 4.

In the light receiving device of the present invention, as already explained, the index-matching material composed of the resin etc. having the predetermined refractive index, is provided between the optical fiber 3 and the light receiving element 4. Therefore, the reflection light from the outgoing end of the optical fiber can be reduced as compared with the cleaved optical fiber.

To be more specific, supposing that the return light occurs at the outgoing end of the optical fiber due to the Fresnel reflection, reflection attenuation quantities (ORLair, ORLmatching) of the fiber end surface in the air and in the index-matching material, can be given by the following formulae:

ORL(matching)=10log (n(fiber)−n(matching)/n(fiber)+−n(matching))=37.09[dB]

ORL(air)=10log (n(fiber)−n(air)/n(fiber)+n(air)) =14.7[dB]

where a refractive index n(fiber) f the core of the optical fiber is 1.45, a refractive index n(matching) f the index-matching material is 1.41, and a refractive index of the air is 1.

As can be understood from the result given above, the reflection attenuation quantity of the fiber end surface within the index-matching material can be more improved by approximately 20 dB than in the air.

Given next is an explanation of the evaluation results of the reflection attenuation quantities of the end surfaces of the outgoing ends of the optical fibers, which are formed respectively by cutting the optical fiber with the blade saw and by cleavage in the state where the index-matching material fills between the optical fiber and the light receiving element.

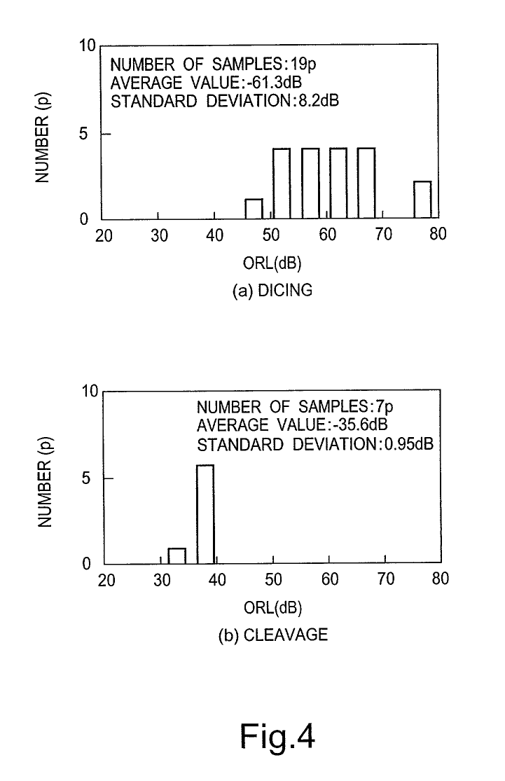

FIG. 4 is a graph showing the evaluation results of the reflection attenuation quantities at the outgoing ends of the optical fibers in the light receiving device having the low reflection characteristic in one embodiment of the present invention. FIG. 4(a) shows the result based on the construction of the light receiving device of the present invention. FIG. 4(b) shows the result based on the construction of the light receiving device in the prior art. Herein, the evaluation is made in such a way that the light assuming a predetermined level is incident from the side opposite to the outgoing end serving as an evaluation target of the optical fiber and reflected from the outgoing end, and a level of the reflection return light is fetched and measured by a directivity coupler. With the evaluation being thus made, it is possible to separately measure the reflection attenuation quantity of the reflection from the light receiving surface of the light receiving element in the light receiving device and the attenuation quantity of the reflection only from the outgoing end thereof.

The evaluation result is that the reflection attenuation quantity from the outgoing end of the cleaved optical fiber is approximately 35 dB, while the reflection attenuation quantity from the outgoing end formed by cutting the fiber with the blade saw is approximately 45˜70 dB. It can be understood that the reflection attenuation quantity is improved by over 10 dB in the light receiving device using the blade saw. It may be said from this evaluation result that it is difficult to ensure a desired reflection attenuation quantity characteristic simply by using what the outgoing end of the optical fiber is cleaved or mirror-finished by polishing as in the prior art, filling it with the index-matching material. The light receiving device capable of ensuring the sufficient reflection attenuation quantity characteristic while providing the vertical outgoing end which has been conceived impossible so far, is actualized by the combining the index-matching material with the cutting processing with the blade saw.

The first embodiment of the light receiving device according to the present invention has been discussed so far, and next a second embodiment will be described.

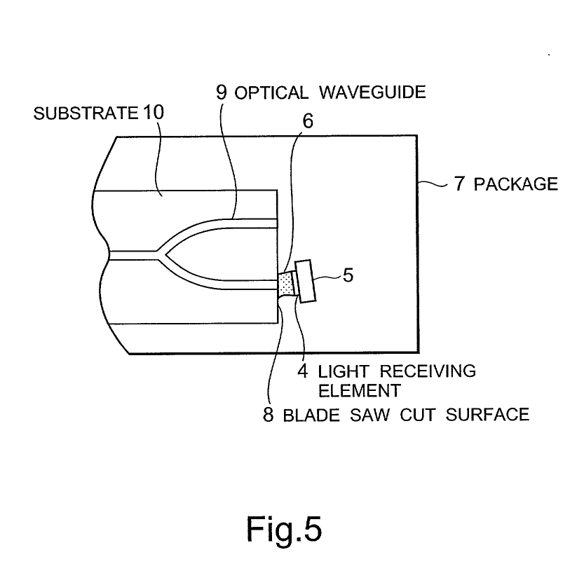

FIG. 5 is a diagram showing a construction of the light receiving device in the second embodiment of the present invention. Though basically structured in the same way as the first embodiment, the light receiving device is herein characteristically constructed of the light receiving element 4 and, as a substitute for the optical fiber 3, e.g., a quartz optical waveguide 9 formed on the surface of a silicon substrate 10. This construction may be applied to a bidirectional optical transmission module by giving, e.g., a wavelength multiplexing function through the quartz optical waveguide.

In the light receiving device in which the optical waveguide 9 is coupled with the light receiving element 4, the outgoing end of the optical waveguide 9 is configured likewise by cutting it with the blade saw, and the index-matching material 6 fills between the outgoing end and the light receiving surface, whereby the reflection attenuation quantity can be reduced. In the case of the optical waveguide substrate, normally one single wafer is sliced into several to several tens of pieces of substrates. Supposing that the outgoing end is obliquely cut and finished by polishing in order to ensure the reflection attenuation quantity characteristic as in the prior art, it follows that the number of substrates sliced out of the wafer naturally decreases. By contrast, the construction of the present invention does not require the oblique cutting and is therefore more excellent in terms of this point also than in the prior art.

As discussed above, in the light receiving device having the low reflection characteristic according to the present invention, even when vertically forming the outgoing end of the optical waveguide medium such as the optical fiber and the optical waveguide without being obliquely formed as done in the prior art, the sufficient reflection attenuation quantity characteristic can be ensured. The outgoing end can be vertically formed without being obliquely formed, and hence the signal light is always emitted in the same direction as the optical fiber etc. extends. The characteristic is not destabilized depending on the direction of the optical path even when the light receiving element is disposed obliquely to the optical fiber etc.

The outgoing end can be constructed by cutting with the blade saw, in other words, the reflection attenuation quantity characteristic can be ensured by positively utilizing the ruggedness on the outgoing end which appears when cut with the blade saw, and therefore the mass productivity is more excellent than by the conventional polishing finish on the occasion of forming the outgoing end.

While this invention has been described in connection with certain preferred embodiments, it is to be understood that the subject matter encompassed by way of this invention is not to be limited to those specific embodiments. On the contrary, it is intended for the subject matter of the invention to include all alternative, modification and equivalents as can be included within the spirit and scope of the following claims.

What is claimed is:

1. A light receiving device comprising:
an optical waveguide medium for emitting a beam of signal light from an outgoing end; and
a light receiving element for receiving said signal light by a light receiving surface and converting the signal light into an electric signal,
wherein said outgoing end is a surface formed by cutting said optical waveguide medium with a blade saw so as to be substantially perpendicular to a traveling direction of said signal light, and
an index-matching material exhibiting a refractive index larger than 1 fills between said outgoing end and said light receiving surface.

2. A light receiving device according to claim 1, wherein said surface roughness Rz of the surface is on the order of over 0.04 μm.

3. A light receiving device according to claim 1, wherein said blade saw has an abrasive grain specified by a grain number smaller than #2000.

4. A light receiving device according to claim 2, wherein said surface roughness Rz of the surface is on the order of 0.06 μm or under.

5. A light receiving device according to claim 3, wherein said blade saw is specified by a grain number larger than #500.

6. A light receiving device having a low reflection characteristic, comprising:
an optical waveguide medium for emitting a beam of signal light from an outgoing end; and
a light receiving element for receiving said signal light by a light receiving surface and converting the signal light into an electric signal,
wherein said outgoing end is a surface formed substantially perpendicular to a traveling direction of said signal light, of which said surface roughness Rz is over 0.04 μm, and
an index-matching material exhibiting a refractive index larger than 1 fills between said outgoing end and said light receiving surface.

7. A light receiving device according to claim 6, wherein said surface is formed by a final polishing finish using an abrasive grain specified by a grain number smaller than #2000.

8. A light receiving device according to claim 6, wherein said surface roughness Rz of the surface is on the order of 0.06 μm or under.

9. A light receiving device according to claim 7, wherein said abrasive grain is specified by a grain number larger than #500.

10. A light receiving device according to claim 1, wherein said light receiving element is disposed so that said light receiving surface is oblique to the traveling direction of said signal light.

11. A light receiving device according to claim 1, wherein said optical waveguide medium is an optical fiber, and
said outgoing end is formed perpendicular to said optical fiber.

12. A light receiving device according to claim 1, wherein said optical waveguide medium is an optical waveguide, and
said outgoing end is formed perpendicular to said optical waveguide.

13. A light receiving device having a low reflectance characteristic according to claim 11, further comprising:
a substrate formed with a groove in which to dispose said optical fiber; and
a package in which said substrate and said light receiving element are disposed, said optical fiber and said light receiving element being optically directly coupled.

14. A light receiving device according to claim 12, further comprising:
a package in which said substrate formed with said optical waveguide and said light receiving element are disposed, said optical waveguide and said light receiving element being optically directly coupled.

15. A light receiving device according to claim 6, wherein said light receiving element is disposed so that said light receiving surface is oblique to the traveling direction of said signal light.

16. A light receiving device according to claim 6, wherein said optical waveguide medium is an optical fiber, and
said outgoing end is formed perpendicular to said optical fiber.

17. A light receiving device according to claim 6, wherein said optical waveguide medium is an optical waveguide, and
said outgoing end is formed perpendicular to said optical waveguide.

18. A light receiving device having a low reflectance characteristic according to claim 17, further comprising:
a substrate formed with a groove in which to dispose said optical fiber; and
a package in which said substrate and said light receiving element are disposed, said optical fiber and said light receiving element being optically directly coupled.

19. A light receiving device according to claim 18, further comprising:
a package in which said substrate formed with said optical waveguide and said light receiving element are disposed, said optical waveguide and said light receiving element being optically directly coupled.
